(19) United States
(12) Patent Application Publication
(10) Pub. No.: US 2013/0254792 A1
(43) Pub. Date: Sep. 26, 2013

(54) METHOD AND APPARATUS FOR USING LOW POWER RF CIRCUITS AND EDID DATA AND CONTROL FOR DISPLAY MONITORING

(71) Applicant: Gregory Charles Herlein, San Francisco, CA (US)

(72) Inventor: Gregory Charles Herlein, San Francisco, CA (US)

(73) Assignee: THOMSON LICENSING, Issy de Moulineaux (FR)

(21) Appl. No.: 13/991,006

(22) PCT Filed: Sep. 2, 2011
(86) PCT No.: PCT/US11/50281

§ 371 Date: May 31, 2013

Related U.S. Application Data
(60) Provisional application No. 61/428,409, filed on Dec. 30, 2010.

(51) Int. Cl. H04N 21/24

(52) U.S. Cl. CPC H04N 21/24
USPC 725/14

(57) ABSTRACT

A method and means for display control and monitoring include an extended display identification (EDID) means and communicating with the display using radio frequency communication and extended display identification commands via the extended display identification means to monitor the display's status and to control the display's functionality controllable via the extended display identification commands. The means can include an EDID circuit for interfacing with a display and communicating with at least the display using EDID packets, an RF interface for providing RF communications, an antenna for receiving and transmitting RF packets and a processor for translating the received RF packets to EDID packets and vice-versa.

### CROSS-REFERENCE TO RELATED APPLICATIONS

This patent application claims the benefit of and/or priority to U.S. provisional patent application Ser. No. 61/428,409 filed Dec. 30, 2010, the entire contents of which is specifically incorporated herein by reference.

### FIELD OF THE INVENTION

The present invention generally relates to display monitoring and, more particularly, to a method and apparatus for using low power radio frequency circuits and devices and extended display identification (EDID) data and control capabilities for display monitoring and control.

### BACKGROUND OF THE INVENTION

In content distribution networks, such as retail advertising networks associated with digital signage, it is common to perform proof of playback logging so that advertisers can be assured that the advertising media actually played. In advanced deployments, commercial grade televisions/displays having query and response technologies are used to obtain reliability metrics and to also obtain the ability to control and monitor the televisions/displays. For example, in some applications, commercial screens that support a serial port using proprietary protocols are used. In addition, some commercial applications require the use of a set-top box (STB) that supports EDID query and a consumer electronics control (CEC) line to determine a state of the attached screen. However, both of those solutions require software on the STB and attached wires to the screens to perform the monitoring and control functions which add cost to such a system. In addition, commercial screens are more expensive than residential CE labs equipment.

### SUMMARY OF THE INVENTION

Embodiments of the present invention address the deficiencies of the prior art by providing a method and apparatus for using low power radio frequency circuits and extended display identification (EDID) data and control capabilities for display monitoring and control. Embodiments of the present invention provide the monitoring and control features of commercial grade screens using less-expensive residential grade screens while remaining independent of whatever media playback equipment is in use.

In one embodiment of the present invention, the use of a low power RF communications network (e.g., ZigBee®) combined with an HDMI/DVI/VGA circuit/plug enable the query of EDID data of an attached display to determine if the display is powered and operational.

In alternate embodiments of the present invention, an RF command set controls standby/resume modes of a display using the EDID packets if such modes are supported by the display.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention is applied;

FIG. 2 depicts a high level block diagram of an EDID circuit device in accordance with an embodiment of the present invention;

FIG. 3 depicts a high level block diagram of an EDID circuit device of FIG. 2 in accordance with an alternate embodiment of the present invention;

FIG. 4 depicts a high level block diagram of an EDID circuit in accordance with an embodiment of the present invention;

FIG. 5 depicts a high level block diagram of the EDID circuit of FIG. 4 in accordance with an alternate embodiment of the present invention; and

FIG. 6 depicts a high level block diagram of an EDID circuit including HDMI and CEC capabilities in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and apparatus for using low power radio frequency circuits and extended display identification (EDID) data and control capabilities for display monitoring and control. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in any content distribution or communications network for display monitoring and control.

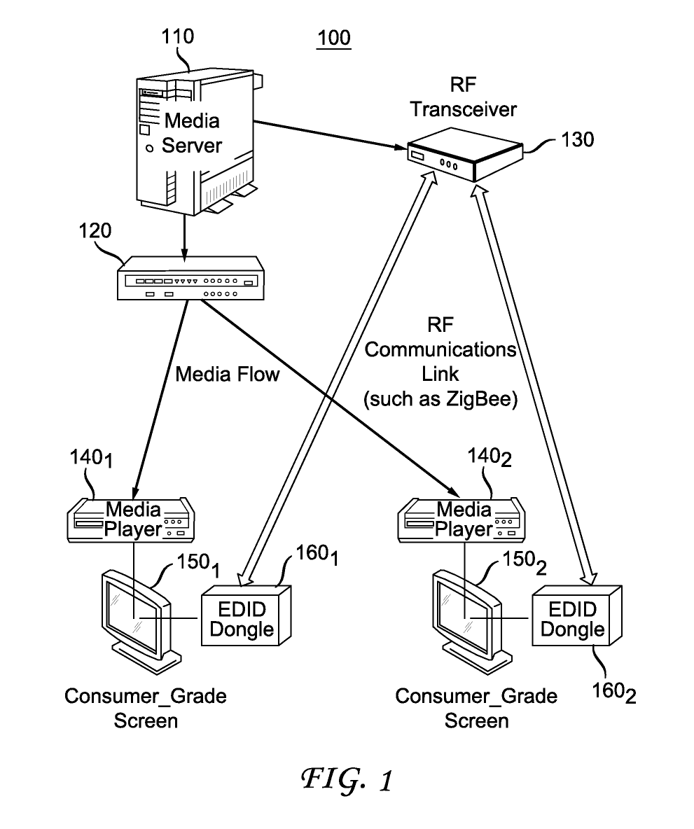

FIG. 1 depicts a high level block diagram of a content distribution system in which an embodiment of the present invention is applied. The system 100 of FIG. 1 illustratively comprises a media server 110, a device for media flow control such as a network operating center or network management center 120, an RF transceiver 130, two media players 140₁, 140₂, two consumer-grade display screens 150₁, 150₂ and two associated EDID circuit devices 160₁, 160₂ in accordance with one embodiment of the present invention. In the system 100 of FIG. 1, the media server communicates content through the media flow device 120 to the media players 140₁, 140₂. The content from the media players 140₁, 140₂ is displayed on the respective consumer-grade display screens 150₁, 150₂.

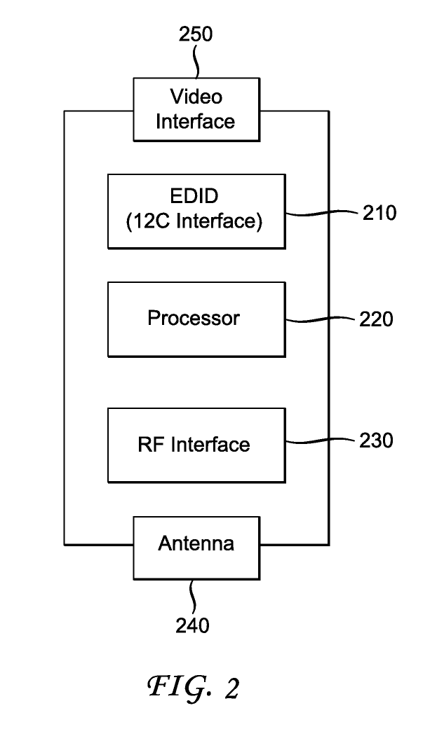

In accordance with an embodiment of the present invention, the media server 110 communicates with the respective consumer-grade display screens 150₁, 150₂ using the RF transceiver 130 and an RF interface associated with the EDID circuit devices 160₁, 160₂ (See FIG. 2). That is, in the embodiment of FIG. 1, the EDID circuit devices 160₁, 160₂ take the form of a small dongle that plugs into an unused port on the respective consumer-grade display screens 150₁, 150₂. The dongles 160₁, 160₂ use the DDC line on the HDMI/DVI/VGA port to query the respective consumer-grade display screens 150₁, 150₂ to determine information of the respective consumer-grade display screens 150₁, 150₂, such as the manufacturer, model and capability set.

To clarify, EDID is a two-way communications system based on I2C technology and data packets are typically sent with 30 ms between them. The capability is fully detailed in CEA-861 and public information is available at http://en.wikipedia.org/wiki/Extended_display_identification_data. In accordance with the concepts of the present invention, EDID technology is used to query the status of displays such as the consumer-grade display screens 150₁, 150₂ of FIG. 1. If a display is not powered there will be no reply to the query. If the display has power, the display will reply with a data packet that identifies the display. Parsing the reply data packet from the queried display results in information about that display.

For example, the following is a summary of the data reported by an Envision EN-775e monitor:

| | |
|---|---|
| Monitor Name | EPI EnVision EN-775e |
| Monitor ID | EPID775 |
| Model | EN-775e |
| Manufacture Date | Week 26/2002 |
| Serial Number | 1226764172 |
| Max. Visible Display Size | 32 cm × 24 cm (15.7 in) |
| Picture Aspect Ratio | 4:3 |
| Horizontal Frequency | 30-72 kHz |
| Vertical Frequency | 50-160 Hz |
| Maximum Resolution | 1280 × 1024 |
| Gamma | 2.20 |
| DPMS Mode Support | Active-Off |

### Supported Video Modes:

| | |
|---|---|
| 640 × 480 | 140 Hz |
| 800 × 600 | 110 Hz |
| 1024 × 768 | 85 Hz |
| 1152 × 864 | 75 Hz |
| 1280 × 1024 | 65 Hz |

### Monitor Manufacturer:

| | |
|---|---|
| Company Name | Envision, Inc. |

The EDID dongle of the embodiment of FIG. 1 also has an RF module/interface (See FIG. 2) on it that uses any of several common RF network technologies (such as ZigBee®). In one embodiment of the present invention, the EDID dongle of the present invention supports the ability for a master node (e.g., media server 110 of FIG. 1) to query each EDID dongle by a unique address to the EDID dongle to determine into what display the EDID dongle is plugged. If the EDID dongle does not get a reply from an associated display, it can be inferred that the EDID dongle is either not plugged into a display or that the display is not powered on.

By sending commands to specific EDID dongles in accordance with the concepts of the present invention, the media server can determine the serial number of the display into which that the dongle is plugged, thus uniquely identifying the display screen. An important fact that can be gained from a reply of a query of the present invention is that the display is operating.

In an embodiment in which a display supports power control over EDID (as described in byte 24 of the first EDID data block) then the EDID dongle of the present invention will respond to ‘power suspend’ commands from the RF side by using the EDID command to place the screen in standby. In accordance with the present invention, the EDID dongle allows a command to be sent to the EDID dongle over RF to accomplish the functionality described herein in accordance with the concepts of the present invention. This enables displays to be turned on and off by issuing commands via the EDID dongle.

FIG. 2 depicts a high level block diagram of an EDID circuit device in accordance with an embodiment of the present invention. The EDID circuit device of FIG. 2 illustratively comprises an EDID dongle. The EDID dongle of FIG. 2 illustratively comprises an EDID I2C interface 210, a processor 220, an RF interface 230 and an antenna 240. The EDID dongle of FIG. 2 further comprises a plug 250 for interfacing with a display. In the embodiment of FIG. 2, the EDID dongle implements the RF interface 230 and the EDID interface 210 connected through a microcontroller or microprocessor 220 to listen to RF packets and translate them to EDID packets, and vice versa. That is, the EDID dongle of FIG. 2 also listens to EDID packets and translates them to RF packets. The plug 250 of the EDID dongle can comprise any EDID compatible plug such as HDMI, VGA or DVI to plug into, for example, an unused video port of a display device.

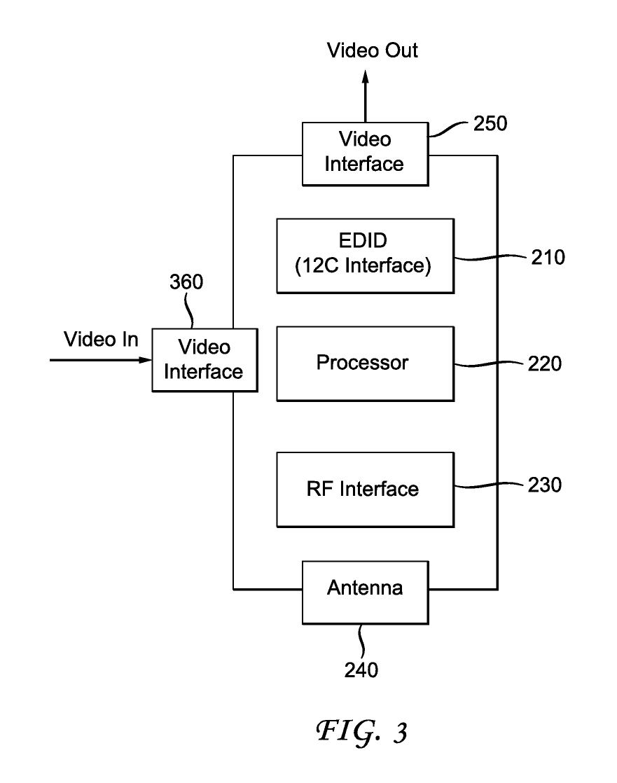

FIG. 3 depicts a high level block diagram of an EDID circuit device of the invention in accordance with an alternate embodiment of the present invention. In the embodiment of FIG. 3, the EDID dongle does not need an unused video port as in the embodiment of FIG. 2. More specifically, similar to the EDID dongle of FIG. 2, the EDID dongle of FIG. 3 illustratively comprises an EDID I2C interface 210, a processor 220, an RF interface 230, an antenna 240 and a plug 250. The EDID dongle of FIG. 3, however, further comprises a second connector 360 for interfacing with, for example an existing communication cable. That is, the EDID dongle of FIG. 3 can be used in-line with a used video port. That is, in the EDID dongle of FIG. 3, all the electronics and communications except the EDID line and communications are passed directly through the EDID dongle unchanged. The EDID dongle of FIG. 3 operates such that communications are processed in such a way that a video source is unaware that it is not connected directly to the display. However, the EDID data is made available to the controller and the RF module as described herein. That is, in the embodiment of FIG. 3, the EDID dongle supports “pass through” to an actual cable plugged into the display. In such an embodiment, the cable to a media player, such as a set-top box or video source, would plug into the EDID dongle and the EDID dongle would plug into the display. The EDID dongle retains its normal functionality described herein, but also mimics everything normal to the cable connection. This mimic function would be such that the connected source would be unaware that it was not directly connected to the display. However, the various embodiments of the EDID dongle of the present invention would be providing the described functionality using the RF network as the control fabric as described herein.

Although in the embodiment of FIG. 1, the displays of the system of FIG. 1 are illustrated as consumer-grade display screens, in alternate embodiments of the present invention, the concepts of the present invention can be applied to commercial displays and custom-built screens as well. For example, if a manufacturer takes commercially available consumer-grade screens (or components that make up those screens, such as LCD panels) and internally to a new mounting enclosure provides an RF radio link to control the unit through EDID technology as outlined above, such displays can be queried and controlled in accordance with the concepts of the present invention.

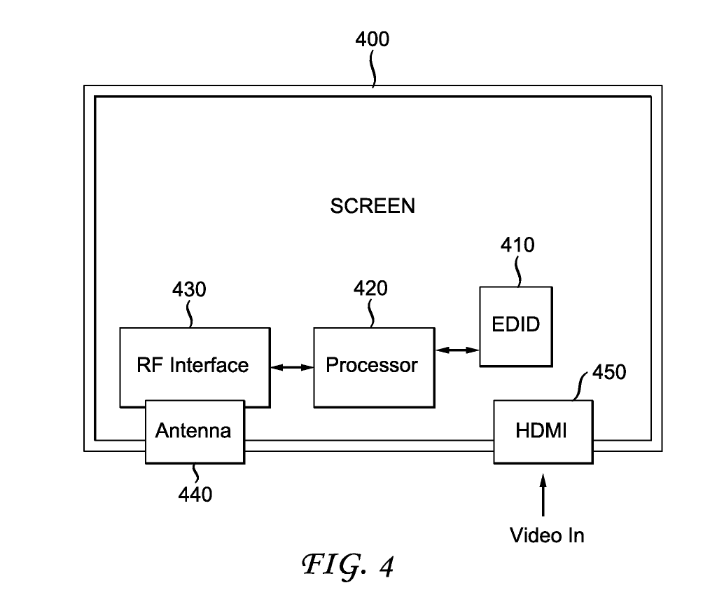

FIG. 4 depicts a high level block diagram of an EDID circuit in accordance with an alternate embodiment of the present invention. The EDID circuit of FIG. 4 depicts an embodiment of EDID circuit device of the present invention implemented into a display 400 and not as a separate EDID dongle. The EDID circuit 400 of FIG. 4 illustratively comprises an EDID I2C interface 410, a processor 420, an RF interface 430 and an antenna 440. The EDID circuit of FIG. 4 is illustratively integrated into the display. In the embodiment of FIG. 4, the display comprises an HDMI interface 450 for receiving video. In the embodiment of the EDID circuit of FIG. 4, the firmware on the processor listens to RF packets and translates them to EDID packets, and vice versa. As such, the EDID circuit of the present invention can monitor and control the display in accordance with the above described concepts of the present invention.

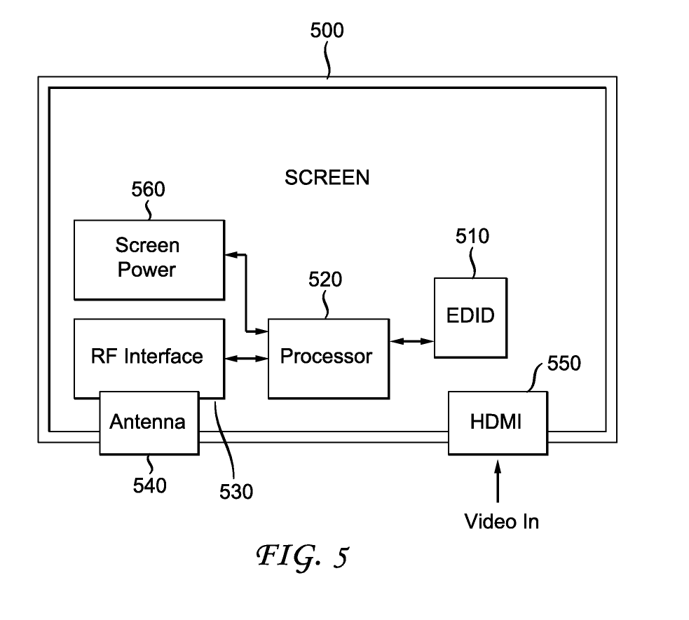

In an alternate embodiment of the present invention, the processor can control the power to the display separately if that solution is more appropriate to an application. For example, FIG. 5 depicts a high level block diagram of the EDID circuit in accordance with an alternate embodiment of the present invention. The EDID circuit of FIG. 5 illustratively comprises an EDID I2C interface 510, a processor 520, an RF interface 530 and an antenna 540. The EDID circuit of FIG. 5 is also illustratively integrated into the display 500. In the EDID circuit of FIG. 5, the processor 520 is in direct communication with the power circuit 560 of the display such that the power of the display can be monitored and controlled directly via the EDID circuit instead of having to communicate and control the power of the display via the display circuitry. In the embodiment of FIG. 5, the display comprises an HDMI interface 550 for receiving video.

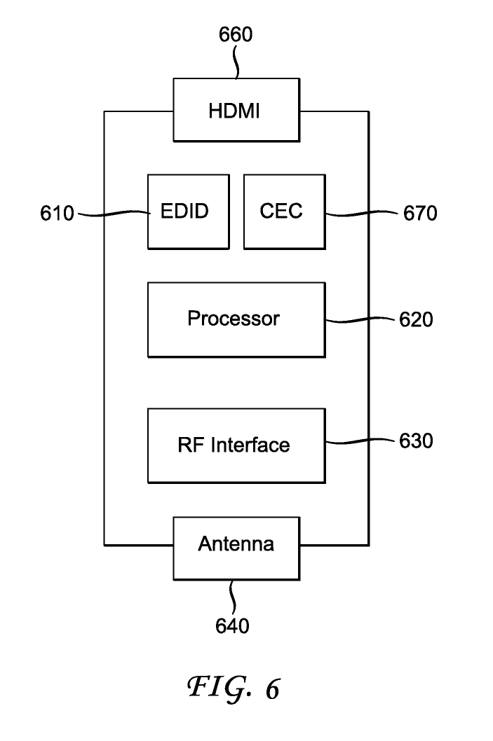

FIG. 6 depicts a high level block diagram of an EDID circuit including HDMI and CEC capabilities in accordance with an embodiment of the present invention. That is the EDID circuit of FIG. 6 illustratively comprises an EDID dongle including an EDID I2C interface 610, a processor 620, an RF interface 630 and an antenna 640. The EDID dongle of FIG. 6 further comprises an HDMI connector 660 and a CEC line and circuitry 670. In the embodiment of FIG. 6, the command set across the RF link includes the ability to query a display in accordance with the embodiments of the present invention described herein and the HDMI and CEC capabilities are implemented to control various functionalities of the display as is known in the art. More specifically, as depicted in FIG. 6, an EDID circuit/dongle of the present invention can further include a CEC circuit 670 for communicating with and controlling a display using CEC capabilities.

Having described various embodiments for a method and apparatus for a method, apparatus and system for using low power radio frequency circuits and extended display identification (EDID) data and control capabilities for display monitoring and control (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for monitoring and controlling a display, comprising:
equipping a display with an extended display identification communication means; and
communicating with the display using radio frequency communication and extended display identification commands via the extended display identification means to monitor the display's status and to control the display's functionality controllable via the extended display identification commands.

2. The method of claim 1, further comprising communicating a query to individual extended display identification communication means using a unique address to determine a respective display into which an extended display identification communication means is connected.

3. The method of claim 1, wherein equipping a display with an extended display identification communication means comprises connecting an extended display identification device into an unused communications port of the display.

4. The method of claim 3, wherein said extended display identification device comprises a dongle and the unused communications port comprises an unused video port.

5. The method of claim 3, wherein said extended display identification device comprises a radio frequency interface.

6. The method of claim 1, wherein equipping a display with an extended display identification communication means comprises placing an extended display identification device in-line with a video cable connected to the display.

7. The method of claim 1, wherein equipping a display with an extended display identification communication means comprises integrating an extended display identification device into the display.

8. The method of claim 1, wherein communicating with the display using radio frequency communication comprises using a display data channel line on an HDMI/DVI/VGA port of the display to query the display to determine information of the display such as the manufacturer, model and capability set.

9. The method of claim 1, where a display's power setting can be monitored and controlled using the radio frequency communication and extended display identification commands.

10. An apparatus for display control and monitoring, comprising:
an extended display identification (EDID) circuit for interfacing with a display and communicating with at least the display using EDID packets;
an RF interface for providing RF communications;
an antenna for receiving and transmitting RF packets; and
a processor for translating the received RF packets to EDID packets and vice-versa.

11. The apparatus of claim 10, wherein said EDID circuit includes an HDMI interface.

12. The apparatus of claim 10, further comprising an HDMI interface for receiving video.

13. The apparatus of claim 10, wherein said apparatus comprises an integrated component of a display.

14. The apparatus of claim 10, further comprising a consumer electronics control (CEC) circuit for further communicating and controlling a display using CEC capabilities.
